(19) United States
(12) Patent Application Publication
(10) Pub. No.: US 2013/0343326 A1
(43) Pub. Date: Dec. 26, 2013

(54) TRANSFERRING OF INFORMATION IN ELECTRONIC PRICE LABEL SYSTEMS

(71) Applicant: Jarmo Kivinen, Helsinki (FI)

(72) Inventor: Jarmo Kivinen, Helsinki (FI)

(73) Assignee: MARISENSE OY, Vantaa (FI)

(21) Appl. No.: 14/004,079

(22) PCT Filed: Mar. 8, 2012
(86) PCT No.: PCT/FI2012/050229

§ 371 Date: Sep. 9, 2013

(30) Foreign Application Priority Data
Mar. 10, 2011 (FI) 20115238

(51) Int. Cl. H04B 7/04

(52) U.S. Cl. CPC H04B 7/04
USPC 370/329

(57) ABSTRACT

Electronic price label system, comprising at least one base station(7) and a plurality of electronic labels(5a, 5b) wherein the base 5b station(s) (7) and the electronic labels (5a, 5b) comprise at least communication means and information is transferred between the base station(s) (7) and electronic labels (5a, 5b). The base station (7) or the base stations (7) are configured to send and receive information at first frequency band and second frequency band and, the electronic labels (5a, b) are configured to send and receive at a first frequency band and a second frequency band.

### TECHNICAL FIELD

The invention relates to electronic price label systems comprising at least one base station and plurality of electronic labels. The invention relates especially to transferring of information between base stations and electronic labels.

### BACKGROUND OF THE INVENTION

Conventionally, the price information on price tags in shops is always changed manually when the price of the product is changed. The new prices are printed out on paper or a corresponding material, and these tags with their new price markings are placed manually in a location reserved for the price tags on shelves in the sales premises. Thus, an employee must first find the correct location of the price tag to be updated, after which the previous price tag is removed and discarded and the new price tag is inserted in its position. A disadvantage in this arrangement is, among other things, the fact that the arrangement is very laborious and there is a high risk of mistakes. In case of a mistake, a situation may, for example, occur, in which the price information on the price tags on the shelves conflicts with the price information in the cash register system.

To avoid the above-mentioned drawbacks, electronic systems have been developed, in which electronic price labels and their electronic displays are provided on the front edge or above the shelves, close to the products, in which the price information of the products can be changed in a centralized manner from the control centre of the system, or the like. This will facilitate and accelerate the updating of the price information to a significant extent. The data on the displays can be updated in a cabled or wireless manner, depending on the system. Cabled systems involve the problem that a wire connection must be provided for each display for data transmission and possibly also for power supply. For example in a normal retail outlets for daily consumer goods, the number of displays is relatively large; consequently, there must also be a large number of wires, which causes problems and limitations, for example, on the placement of the price displays.

Wireless systems do not require complex wirings but, in turn, they require transponders equipped with antennas in connection with battery-driven price displays, for communicating with the control unit of the system via suitable communication means.

When the aim is to minimize the power consumption of the electronic price labels and thereby to extend the service life of their batteries, one method in the communication between the communication means and the electronic price labels is such in which the transducer placed in the electronic price labels does not, by itself, implement active radio transmission so that the transmission power would be supplied from a separate power supply of the electronic price label, but the electronic price label only reflects the radio transmission of the communication means at a given moment of time and in a given way. The electronic price label can change the reflectance of its own antenna, wherein the electronic price label is capable of acknowledging or responding to messages of the communication means by simple reply messages. In the following, such a communication method will be described on a general level.

The communication means communicate with the electronic price labels by transmitting signals which are listened to by all the electronic price labels and from which a single electronic price label identifies a command relating to itself on the basis of a given electronic price label specific identification. After receiving a command relating to itself, the single electronic price label responds to the communication means by reflecting the transmission of the communication means itself back to the communication means, changed by a phase shift caused by a given time delay and at a given moment of time. Typically, after transmitting a command intended for a given price display, the communication means starts to transmit, for example, a carrier wave of a given type for a given period of time, the carrier wave being reflected back, with a given phase shift, by the price display that recognized the command. Consequently, the communication means is capable of identifying the reflected response as belonging to a given price display, because it knows to expect it within a given period of time after sending a unique command to said display. From its own transmission, the communication means can separate the reflected response that is significantly weaker in power, on the basis of the phase shift produced by the display device.

Because these reflected response signals are typically very weak and they can be disturbed and suppressed by other ambient reflections or signals, there is a need to reduce to improve the quality of the received signal by all possible means. Also base stations' transmission can be disturbed for example by the shelves and articles to be sold in the store.

Weakening of the signal caused by reflections is called fading. Fading reduces performance of the system and the current solution to compensate fading has been to have higher density of base stations. That creates high cost and high complexity for the system. Another way to keep system performance at acceptable level despite of fading is to use antenna diversity but that as well results in more expensive and complex system.

### SUMMARY OF THE INVENTION

It is an aim of the present invention to reduce the above-mentioned problems and simultaneously to provide a low-cost, simple and reliable arrangement for improving the performance of communications at radio frequencies between base stations and electronic price labels. The invention is characterized in what will be presented in the characterizing part of independent claims. Other embodiments of the invention are characterized in what will be presented in the other claims.

The solution of the invention is to use two different frequency bands in transmission of information from base stations to electronic labels and from electronic labels to base stations. The using of two different frequency bands creates diversity gain and signal-to interference ratio is improved with larger frequency range of the system.

According to present invention, base stations and electronic labels send and receive information using two different frequency bands. Once base station or electronic label receives the signal sent by electronic labels or base stations on two different frequencies, diversity combining technique is used to combine the multiple received signals of a diversity reception into a single improved signal.

In one embodiment of the invention transfer of the information on two frequency bands is done as simultaneous transmission. This means that the signals in two frequencies are sent simultaneously and received simultaneously.

In another embodiment of the invention transfer of the information on two frequency bands is done as a separate transmission. In separate transmission the signal at one frequency is transmitted first and signal at the second frequency is sent after the first signal.

One advantage of the invention is that the reception quality of base stations and electronic labels is improved. This way the number of base stations can be kept minimum and at the same time costs and complexity of the system are also kept low.

When compared to prior art solutions, also the installation remains simple as the complexity of the system is low, number of the base stations is low and there are no complex antenna diversity arrangements to be installed. It's possible to use antenna diversity in combination with the solution of the present invention to further increase the diversity gain.

### BRIEF DESCRIPTION OF THE DRAWINGS

In the following, the invention will be described in more detail by means of an embodiment example with reference to the appended drawings, in which

FIG. 1 presents an example embodiment of an electronic price label system according to the present invention,

FIG. 2 presents an example embodiment of the electronic price label according to the present invention,

FIG. 3 presents a side view of an example embodiment of the electronic price label according to the present invention,

FIG. 4A presents an exemplary hardware implementation according to the present invention for transferring information simultaneously at first and second frequency,

FIG. 4B presents an exemplary method according to the present invention for transferring information simultaneously at first and second frequency,

FIG. 5A presents an exemplary hardware implementation according to the present invention for transferring information separately at first and second frequency, and

FIG. 5B presents an exemplary method according to the present invention for transferring information separately at first and second frequency.

### DETAILED DESCRIPTION OF THE INVENTION

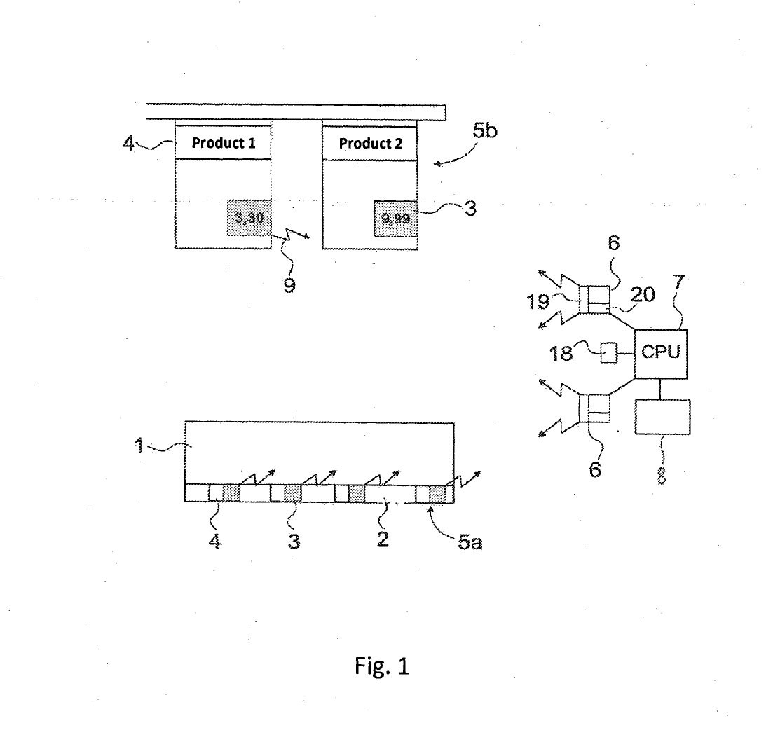

FIG. 1 shows a schematic and simplified view of an arrangement according to the invention in a supermarket or in corresponding sales premises. Product shelves 1 are equipped with shelf rails 2, on which electronic price labels 5a equipped with, for example, electrophoretic laminate displays 3 and product information 4 are placed in locations corresponding to products. The laminate display 3 is arranged to display the price of the product, and the product information 4 contains, among other things, the name of the product and possibly some other information relating to the product. In a corresponding manner, there are, in required locations in the sales premises, hanging electronic price labels 5b forming a display pocket, which also comprise both an electrophoretic laminate display 3 and product information 4. Each electronic laminate display 3, or shortly display 3, constitutes a thin price tag equipped with display segments and resembling a paper price tag, in which the required product prices and other necessary symbols are formed by changing the colour of the substantially two-coloured display segments. One layer of the display is, for example, an active ink layer. The ink layer contains a number of microcapsules filled with liquid and containing, for example, substantially black particles with a positive surface charge and substantially white particles with a negative surface charge, whose location in the microcapsules is controlled by an electric field so that at the desired display segments, the black particles are on top, wherein said display segments look black when viewed from above, and at the other display segments, the white particles are on top, wherein these display segments look white when viewed from above. The back-ground of the display consists of the same microcapsules, wherein, for example, the price information can be displayed as dark numbers against a light background, or vice versa, if desired. Such a display used can be, for example, the electrophoretic microcapsule display laminate disclosed in Finnish patent application No. FI 20050192.

Furthermore, the system comprises at least a base station 7 equipped with communication means 6, such as a radio transmitter, via which it is possible to transmit, for example, updated price information and other control information to the electronic price label 5a, 5b. Furthermore, the system may comprise scanners 8 located at cash registers and connected to the cash register system, for scanning the price, wherein the cash register system and the electronic price labels always have the same up-to-date information on the prices of the products. Furthermore, the base station 7 may be coupled to other controlling and supporting systems. The wireless connection between the base station 7 and the electronic price labels 5a, 5b is illustrated with arrows 9.

The application of the invention is not limited solely to price displays that employ display technology of the above-described kind, but it is obvious that the price displays can, as such, be implemented by applying any known technology. The invention is expressly related to improving wireless radio communications by using two frequency bands for transferring information. Furthermore, the invention is not limited solely to improving performance of radio communications by using two bands for transferring the information in electronic labels systems, but the invention can also be applied in radio communications between other electronic devices. Consequently, the examples presented herein and focusing on price displays must be considered as examples but not the sole embodiments of the invention.

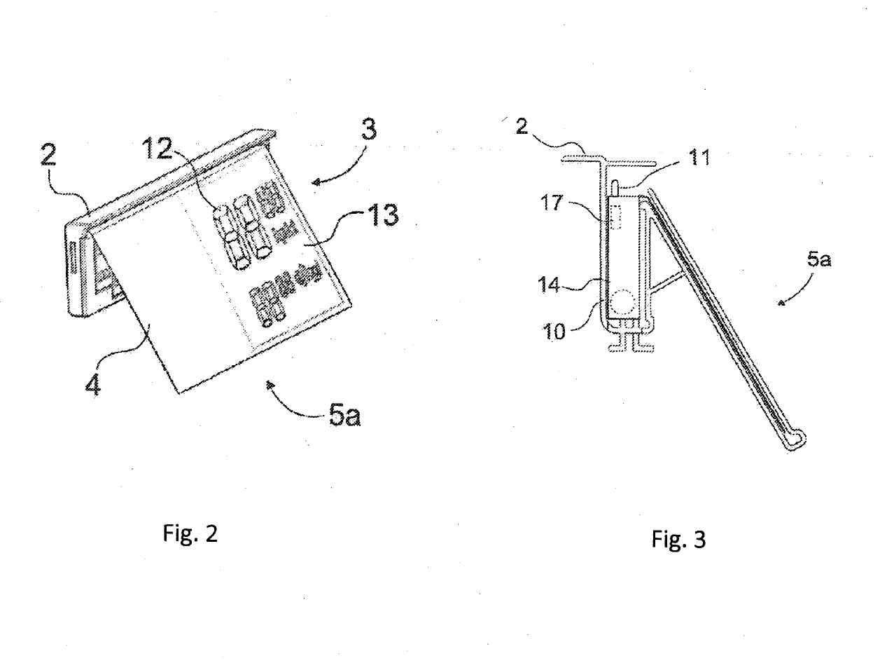

FIGS. 2 and 3 show, in more detail, one example of the type of the electronic price label 5a attached to a shelf rail 2. A display driver 14 connected to the display 3, and a receiver 11 equipped with an antenna, as well as a power source 10, which is, for example, a conventional battery, are fixed to the back of the electronic price label 5a. The power source 10 is arranged to supply electric energy to the electronic price label 5a and its display driver 14. Price information or other information shown on the display 3 by means of the receiver 11 and the display driver 14 can be updated in a wireless manner from the base station 7. In this embodiment example, the updating and control data is transmitted by means of radio waves, but also other ways of data transmission are feasible. Each display laminate 3 constitutes a thin price tag equipped with display segments 12 and resembling a paper price tag, on which the required product prices and other necessary symbols are formed by changing the colour of substantially two-coloured display segments 12. The colour of the display segments 12 as well as of the background 13 is changed by means of an electric field formed by electric current, as described above.

In the arrangement according to the example, the electronic price labels 5a, 5b comprise mode changing means 17 for changing the mode of the antenna of the receiver 11 between at least two different modes, whereby, for example in the first mode, the reflectance of the antenna is good and, in the second mode, the reflectance is poor. In a corresponding manner, the antenna modes can be adjusted by the mode changing means 17 so that the antenna reflects radio waves in different phases in the different modes. Consequently, the electronic price label 5a, 5b is fitted to vary the mode of the antenna of its receiver 11 to produce a reflection encoded in a given way and having a time delay varying according to the antenna mode. The communication means 6 interpret the different time delays as encoded data signals transmitted by the electronic price label 5a, 5b, on the basis of which, for example, the communication means 6 identify each electronic price label. The above-mentioned encoding implies, in its simplest form, that the electronic price label 5a, 5b reflects back the carrier wave transmitted by the communication means 6, which may have a frequency of, for example, 868 MHz so that the electronic price label 5a, 5b grounds the antenna of the receiver 11 by means of the mode changing means 17 at the frequency of, for example, 150 kHz, thereby producing a kind of square wave from the reflected signal. The electronic price label 5a, 5b thus affects the reflected signal by changing the mode of the antenna 11. In this reflection, the phase shift of the signal would be preferably 180 degrees, at which the detection of a low-powered reflection by the communication means 6 is at its best.

The present invention improves this radio communication, which happens between the electronic labels and base station(s) by improving the quality of the transmission by using two different frequency bands in transmission of information from base stations to electronic labels and from electronic labels to base stations.

When the base station is transferring information it does it in two frequencies. In one embodiment of the invention the electronic label doesn't separate different frequency bands. In this embodiment no diversity gain is achieved in transmission from base station to electronic label. This is usually not a problem because base station can use higher transmission power than the electronic label.

In another embodiment of the invention the electronic label receives the signal transmitted by base stations on two different frequencies and uses diversity combining technique to combine the multiple received signals of a diversity reception into a single improved signal.

When the electronic label transfers signal to the base station e.g. by reflecting the signal back, transferring of the information is done in two frequencies. Therefore even if the electronic label can't separate signal sent on two frequency bands, it can send back its response by using two different bands as long as the received signal has also been sent in two frequency bands. As the base station receives the signal it uses diversity combining technique to combine the multiple received signals of a diversity reception into a single improved signal.

Using the solution of the present invention requires improvements hardware when comparing with the prior art solutions. For example to enable using of two frequency bands in transmission in one embodiment of the invention the electronic label can have wideband RF-circuit and an antenna that has radiating resonances at two frequencies. The base station according to one embodiment of the present invention can have dual band synthesizer which has separate outputs for the two bands, that can be used either simultaneously or separately. The transmitter of the base station can have two RF chains that are combined with a duplexer or a switch. The receiver of the base station can be configured to duplex or switch the received signal to two chains. The antenna on the base station can be a dual frequency antenna that radiates at both used frequency bands.

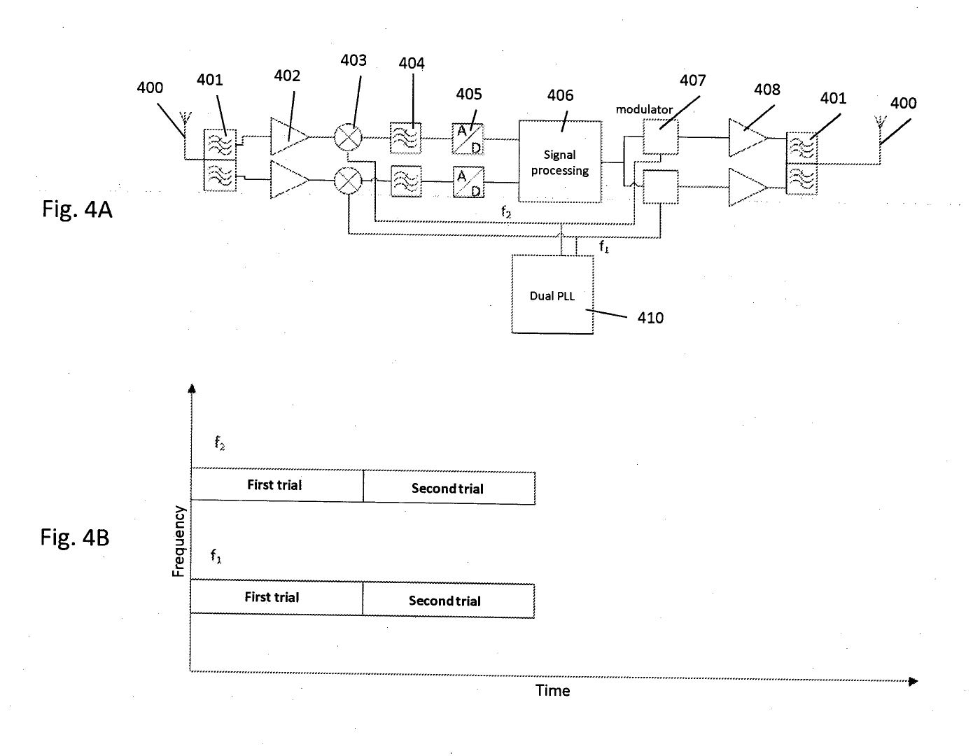

In one embodiment of the invention transfer of the information on two frequency bands is done as simultaneous transmission. This means that the signals in two frequencies are sent simultaneously and received simultaneously as presented in FIG. 4B. If electronic label doesn't separate the signals in reception, simultaneous transmission of two frequencies has diversity only in transmissions from electronic label to base station. In the base station two receiver paths for separate frequencies are needed. When using simultaneous transmission and two RF-chains in the transmitter, the RF-chain can be combined with a duplexer.

In more detailed way, in the simultaneous transmission, two RF bands are transmitted simultaneously. Therefore transmission of the electronic label is obtained at two frequencies also. The signal sent on two bands by the electronic label can be separated at the base station, and the signals can be sampled with two A/D conversions. For example maximal ratio combining algorithm can be used to obtain the diversity of the transmission of the electronic label. In one embodiment of the invention, when base station sends the signal, there is no diversity gain if the electronic label is not able to separate the different frequencies.

FIG. 4A present a more detailed exemplary hardware implementation of the base station for the embodiment that uses simultaneous transmission. The base station comprises an antenna 400 for sending and receiving RF signals on two bands, a duplexer 401 for separating and combining the two bands, a low noise amplifier 402, a mixer 403 for converting the received signal to a suitable frequency for A/D converter, an antialiasing filter 404 for A/D converter, an A/D (analog to digital) converter 405, a signal processing and control module 406 for digital signal, the module 406 can be realized by e.g. FPGA (field programmable gate array), a modulator 407 for modulating the downlink carrier frequency, a power amplifier 408 and, and a dual PLL frequency synthesizer 410 for generating the needed carrier frequencies.

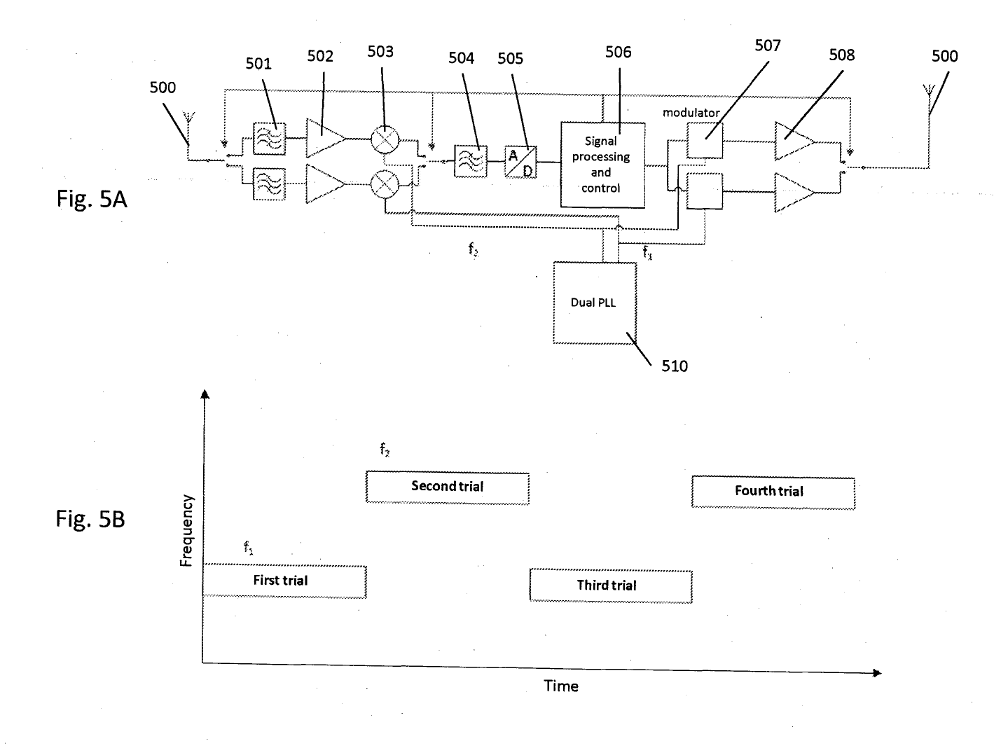

In another embodiment of the invention transfer of the information on two frequency bands is done as a separate transmission. In separate transmission the signal at one frequency is transmitted first and signal at the second frequency is sent after the first signal as presented in FIG. 5B. Separate transmissions on two frequencies create diversity gain in both up- and downlink. The separate transmission can be implemented for example by scanning first all electronic labels with first frequency, and then scanning the electronic labels with the second frequency. By using separate transmission only RF parts of the transmitter need only modification. In this case, when using two RF-chains in the transmitter, the RF-chain can be combined with a switch.

FIG. 5A present a more detailed exemplary hardware implementation of the base station for the embodiment that uses separate transmission. The base station comprises an antenna 500 for sending and receiving RF signals on two bands, a bandpass filter 501, a low noise amplifier 502, a mixer 503 for converting the received signal to a suitable frequency for A/D converter, an antialiasing filter 504 for A/D converter, an A/D (analog to digital) converter 505, a signal processing and control module 506 for digital signal, the module 506 can be realized by e.g. FPGA (field programmable gate array), a modulator 507 for modulating the downlink carrier frequency, a power amplifier 508 and a dual PLL frequency synthesizer 510 for generating the needed carrier frequencies.

In the separate transmission, frequency can be changed for each TTL (Time To Live) frame. First transmission is done with higher frequency, which most likely finds the electronic labels in the vicinity of the base station. The second transmission is then done with lower frequency which can reach electronic labels that are further away from the base station. Moreover, network can allocate the frequencies for each base station to minimize the interference.

In one embodiment of the invention 868 MHz ISM band and 2.4 GHz ISM bands are used as two different frequency ranges. By using two different frequency ranges that are places apart from each other creates high diversity gain because fading of those are not correlating. Also other frequency ranges can be used as two different frequency ranges.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

1. Method for transferring information in an electronic price label system, the electronic price label system comprising at least one base station (7) and a plurality of electronic labels (5a, 5b) for transferring information between the base station (7) and electronic labels (5a, 5b) wherein the base station(s) (7) and the electronic labels (5a, 5b) comprise at least communication means characterized in that the method comprises:
transferring information from base station (7) to electronic label (5a, 5b) and from electronic label (5a, 5b) to base station (7) using a first frequency band and a second frequency band.

2. Method of claim 1, wherein the information is transferred simultaneously on the first and second frequency bands.

3. Method of claim 1, wherein the information is first transferred on the first frequency band and after the transmission has been transferred on the first frequency band, the information is transferred on the second frequency band.

4. Method of claim 1 wherein the first frequency band is 868 MHz ISM-band and the second frequency band is 2.4 GHz ISM-band.

5. Method of claim 1 wherein information to be transferred comprises price information to be displayed by the electronic price label (5a, 5b) or control information for the electronic price label (5a, 5b).

6. Electronic price label of an electronic price label system, the electronic price label system comprising at least one base station (7) and a plurality of electronic labels (5a, 5b), the electronic label (5a, 5b) comprising at least communication means characterized in that,
the electronic label (5a, 5b) is configured to send and receive on a first frequency band and a second frequency band.

7. Electronic price label of claim 6 further comprising electrophoretic laminate display 3.

8. Electronic price label of claim 6 wherein communication means comprise transmitter and receiver.

9. Electronic price label of claim 6 wherein the electronic price label (5a, 5b) is configured to send and receive information simultaneously on the first and the second frequency band.

10. Electronic price label of claim 6 wherein the electronic price label (5a, 5b) is configured to send and receive information first on the first frequency band and after the information has been transferred on the first frequency band, to send and receive information on the second frequency band.

11. Electronic price label of claim 6 wherein the first frequency band is 868 MHz ISM-band and the second frequency band is 2.4 GHz ISM-band.

12. Base station of an electronic price label system, the electronic price label system comprising at least one base station (7) and a plurality of electronic labels (5a, 5b), the base station (7) comprising at least communication means characterized in that,
the base station (7) is configured to send and receive at a first frequency band and a second frequency band.

13. Base station of claim 12 wherein communication means comprise transmitter and receiver.

14. Base station of claim 12 wherein the base station (7) is configured to send and receive information simultaneously on the first and the second frequency bands.

15. Base station of claim 12 wherein the base station (7) is configured to send and receive information first on the first frequency band and after the information has been transferred on the first frequency band, to send and receive information on the second frequency band.

16. Base station of claim 12 wherein the first frequency band is 868 MHz ISM-band and the second frequency band is 2.4 GHz ISM-band.

17. Electronic price label system, comprising at least one base station (7) and a plurality of electronic labels (5a, 5b) wherein the base station(s) (7) and the electronic labels (5a, 5b) comprise at least communication means and information is transferred between the base station(s) (7) and electronic labels (5a, 5b) characterized in that,
the base station (7) or the base stations are configured to send and receive information at a first frequency band and a second frequency band and,
the electronic labels (5a, 5b) are configured to send and receive at the first frequency band and the second frequency band.

18. Method of claim 2 wherein the first frequency band is 868 MHz ISM-band and the second frequency band is 2.4 GHz ISM-band.

19. Method of claim 3 wherein the first frequency band is 868 MHz ISM-band and the second frequency band is 2.4 GHz ISM-band.

20. Method of claim 2 wherein information to be transferred comprises price information to be displayed by the electronic price label (5a, 5b) or control information for the electronic price label (5a, 5b).
